(19) United States
(12) Patent Application Publication
(10) Pub. No.: US 2026/0283110 A1
(43) Pub. Date: Sep. 24, 2026

(54) DOOR DOG

(71) Applicant: VICTOR LORENZO PALAZZOLO, Wellington, FL (US)

(72) Inventor: VICTOR LORENZO PALAZZOLO, Wellington, FL (US)

(21) Appl. No.: 19/377,295

(22) Filed: Nov. 3, 2025

Related U.S. Application Data
(60) Provisional application No. 63/833,171, filed on Nov. 1, 2024.

(51) Int. Cl. A01K 15/02

(52) U.S. Cl. CPC A01K 15/02

(57) ABSTRACT

Animal training devices and methods of use are provided. The training device that attaches to doors and enables an animal, such as a dog, to learn to close doors through a simple, food-motivated process. The system uses a magnetic mounting plate and a spill-proof feeding chamber to create a consistent physical target for the dog to push. Training begins with the device holding food, then gradually transitions to a flat plate and eventually no device at all, allowing dogs to perform the command reliably without visual or food cues. The invention provides an affordable and accessible method for teaching mobility service-related commands that traditionally require expensive professional training. Its magnetic nature allows it to easily attach to refrigerators, car doors, and other magnetic surfaces, offering added convenience and flexibility in training.

### CROSS-REFERENCE TO RELATED APPLICATIONS

This application claims priority pursuant to 35 U.S.C. 119(e) to co-pending U.S. Provisional Patent Application Ser. No. 63/833,171 filed Nov. 1, 2024, the entire disclosure of which is incorporated herein by reference.

### FIELD OF THE INVENTION

The present invention generally relates to animal training devices. More specifically, the invention is directed to animal training devices designed to instruct animals in a systematic training process, particularly in performing mobility service tasks such as closing doors, as well as methods of use thereof.

### BACKGROUND

Training animals, such as dogs, to perform complex tasks such as closing doors, whether residential entry or exit doors, car doors, refrigerator doors, or other similar closures, is a recognized challenge typically requiring professional expertise. Established training protocols often involve significant expense, extended time commitments, and are not readily accessible to the average pet owner. Current training methods suffer from various limitations in both efficacy and practicality. For instance, a common approach is the use of sticky notes applied to door surfaces, intended to act as tactile or visual targets for the animal. While simple to deploy, sticky notes lack consistency, do not reliably adhere to varying surfaces, and fall short by providing no integrated reward mechanism to reinforce the desired behavior. As a result, the animal may struggle to associate the action of closing the door with positive feedback, impeding sustained learning.

Other attempts to address the problem have involved leveraging existing feeding toys or puzzle bowls to motivate animals using food-based rewards. However, such devices are not designed for door-closing training and pose considerable challenges: food often spills during use, creating unwanted mess and potentially distracting the animal from the intended behavior. Moreover, these devices are tailored for food-dispensing puzzles rather than for teaching coordinated actions involving interaction with doors or other closures. Accordingly, the devices and methods in the prior art fail to directly bridge the gap between providing a clear, consistent target, incorporating a motivating reward, and guiding the animal from initial training to independent, reliable performance of the desired behavior. There remains a need in the art for an improved animal training apparatus and corresponding methodology that seamlessly combine these elements.

It would be advantageous to develop a training apparatus and method that presents a physical or visual target to the animal, integrates a food-based incentive to immediately reinforce successful actions, and is specially designed to facilitate the transition from trainer-guided to animal-initiated execution of the intended behavior. Such innovations could make advanced training, such as reliably teaching a dog to close a door, more accessible, efficient, and effective for both professionals and pet owners.

### SUMMARY

The present invention comprises an animal training device and associated methods for instructing animals, such as dogs, by means of a systematic training process. In certain embodiments, the animal training device is specifically configured, along with its methods of use, to facilitate the teaching of mobility service tasks, such as closing doors. These doors may include residential doors, car doors, refrigerator doors, or any flat surface that pivots or rotates about an axis typically perpendicular to the plane of the surface, or similar structures.

In various embodiments, the device enables progressive training for tasks including closing doors or moving objects from a first position to a second position. In some embodiments, the invention comprises a spill-proof food chamber with a flexible membrane flap, a magnetic mounting system that engages a removable steel plate using non-damaging adhesive strips, and a flat transition plate designed to fade the visual target of the device as the animal acquires the desired behavior. The device is compatible with a wide variety of surfaces and doors, such as standard residential doors, car doors, refrigerators, and other magnetic surfaces, enhancing its versatility in different training environments.

In some embodiments, the training process supported by the invention includes initial confidence building with food rewards, attachment of the device to a door, repetition of the target behavior with reinforcement, and a gradual fading of both food motivation and reliance on the device until the animal can perform the task independently. The invention is particularly valuable in training mobility service dogs, offering an affordable and accessible solution for handlers to teach complex skills without expensive professional intervention. Additionally, it serves as an engaging tool for everyday dog owners to challenge their pets, improve obedience, and expand command repertoire beyond basic skills. The device's magnetic mounting further provides convenient repositioning across various doors and surfaces, contributing to its practicality and appeal for a wide range of users.

The foregoing and other objects are intended to be illustrative of the invention and are not meant in a limiting sense. Many possible embodiments of the invention may be made and will be readily evident upon a study of the following specification and accompanying drawings comprising a part thereof. Various features and subcombinations of invention may be employed without reference to other features and subcombinations. Other objects and advantages of this invention will become apparent from the following description taken in connection with the accompanying drawings, wherein is set forth by way of illustration and example, an embodiment of this invention and various features thereof.

### BRIEF DESCRIPTION

Embodiments of the present invention are described in detail below with reference to the attached drawing figures, wherein:

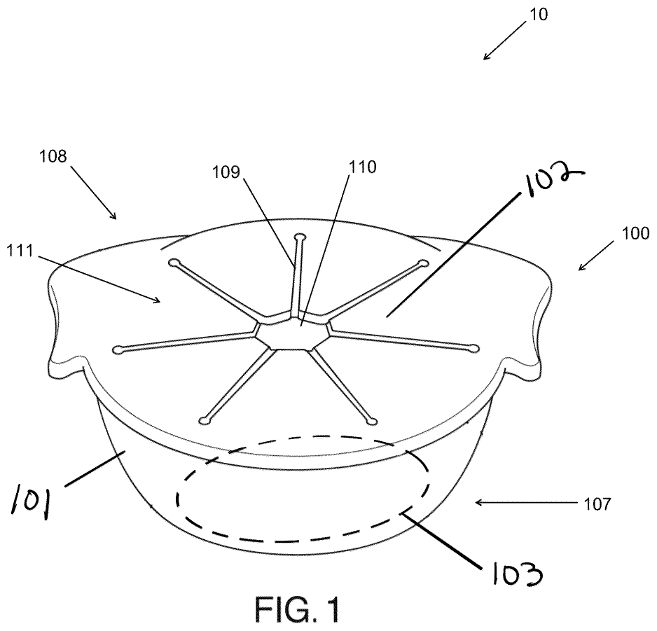

FIG. 1 is a perspective view of one embodiment of an animal training device according to the present invention.

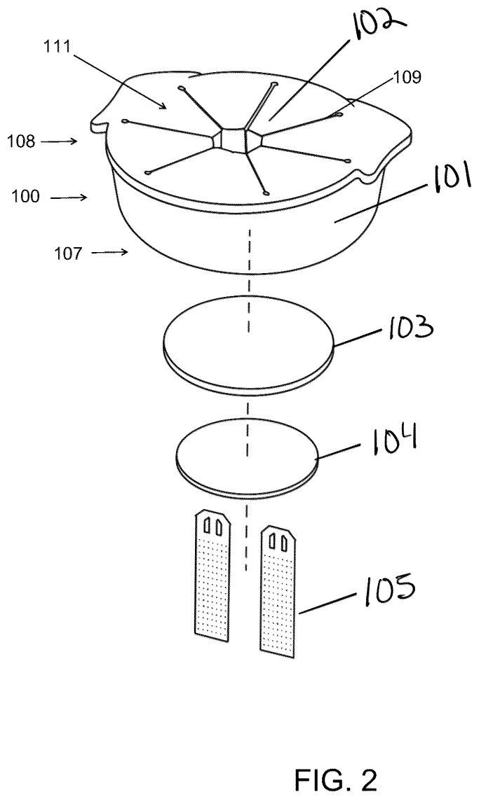

FIG. 2 is an exploded view of one embodiment of an animal training device according to the present invention.

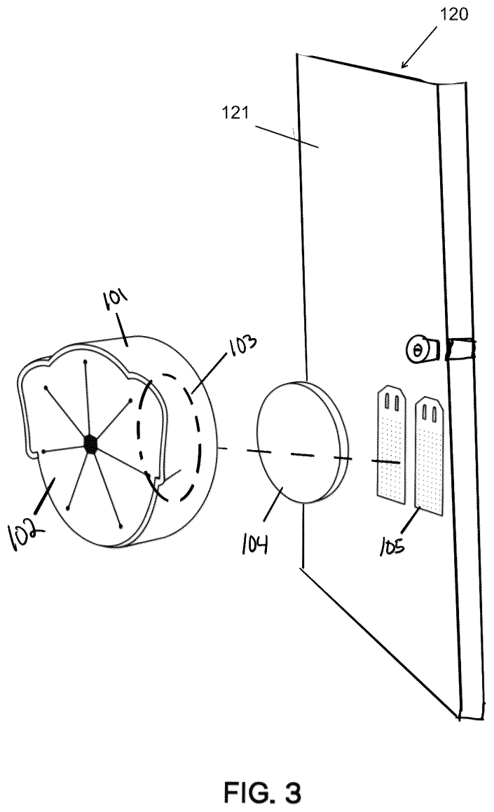

FIG. 3 is a perspective view of one embodiment of an animal training device according to the present invention.

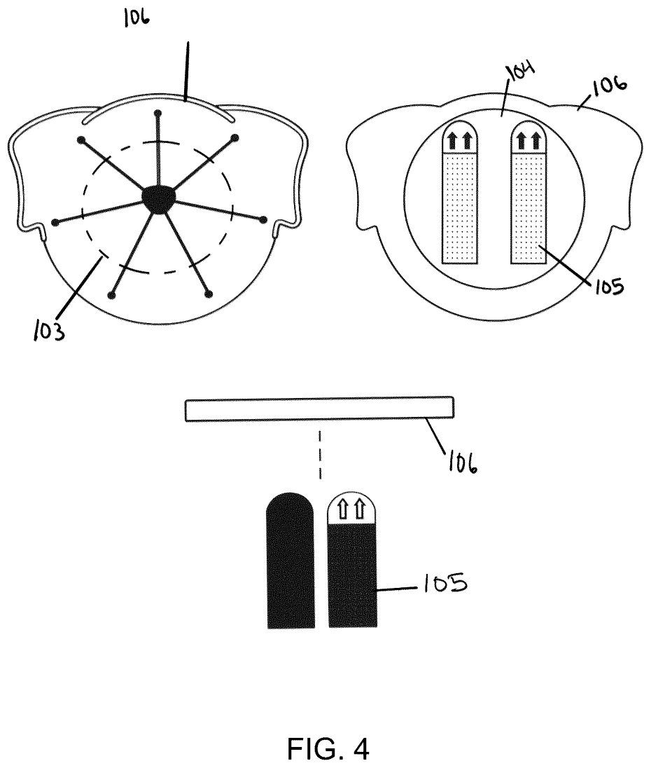

FIG. 4 is a plan view of one embodiment of an animal training device according to the present invention.

The drawing figures do not limit the present invention to the specific embodiments disclosed and described herein. The drawings are not necessarily to scale, emphasis instead being placed upon illustrating the principles of the invention.

### DETAILED DESCRIPTION

As required, a detailed embodiment of the present invention is disclosed herein; however, it is to be understood that the disclosed embodiment is merely exemplary of the principles of the invention, which may be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure.

Generally referring to FIGS. 1 through 4, the present invention discloses an animal training device 10 and methods of use for a training process. In some embodiments, the animal training device 10 is configured to train an animal, such as a dog, a systematic training process. In some embodiments, a systematic training process includes progressive animal training for tasks, such as closing a door. In some embodiments, the systematic training process involves teaching an animal to move an object, such as a door 120, from a first position to a second position.

Referring to FIG. 1, one embodiment of an animal training device 10 is shown. In some embodiments, the animal training device 10 includes a body 100. In some embodiments the body 100 includes a top surface 108 and a base 107, the base 107 being situated opposite the top surface 108. In some embodiments, the body 100 defines in internal cavity 101. In a preferred embodiment of the instant invention, the internal cavity 101 is a void or hollow region formed within the body 100 of the device 10. In certain embodiments, the body 100 comprises a top surface 108 and a base 107, such that at least a portion of the body's 100 material is arranged to surround and enclose the internal cavity 101. The internal cavity 101 is separated from the exterior environment of the device 10, and may be configured to house, contain, animal motivational or reward material, such as training treats. In some embodiments, the internal cavity 101 is a food chamber. In some embodiments of the instant invention, the body 100 is comprised from a durable rubber material or similar resilient material. In some embodiments of the instant invention, the body 100 is comprised from rubber, silicone, or equivalent flexible materials.

Referring to FIG. 1, in a preferred embodiment, the animal training device 10 includes a top surface 108. In some embodiments, the device 10 features a body 100 with the upper surface 108 of the body positioned opposite a base 107. In some embodiments the upper surface 108 is comprised from a durable rubber material or similar resilient material and includes a flexible flap 102. In some embodiments the upper surface 108 is comprised from a durable rubber material or similar resilient material and includes a flexible opening 111. In some embodiments the upper surface 108 is comprised from a durable rubber material or similar resilient material and includes one or more flexible flaps 102. In a preferred embodiment of the present invention, a flexible flap 102 is defined by one or more radial slits 109 extending from a center area of the top surface 108 towards an outer edge of the top surface 108, thereby forming a spill-resistant opening. The location of the upper surface 108 at the top of the body allows for easy animal access, while its structural integration with one or more flexible flaps 102 and slits 109 enables an animal to access food placed within the food chamber 101, while preventing spillage. In some embodiments, the top surface 108 is comprised from a durable rubber material or similar resilient material. In some embodiments, a top surface 108 is a flexible membrane molded into the body 100.

Referring to FIG. 1, in a preferred embodiment of the instant invention, a top surface 108 is configured with a generally planar top surface that is adapted to securely cover a portion of the food chamber 101. In some embodiments, at the center of the top surface 108, a central area is provided, from which a plurality of radial slits 109 extend outward toward the edge of the top surface 108. In some embodiments, the flexible opening 111 is defined by one or more flexible flaps 102. In some embodiments, the one or more flexible flaps 102 allow an animal to easily access the contents of the food chamber 101 by pushing through the flexible opening, while the one or more flexible flaps 102 return to their original position to help prevent spills or leakage. The configuration of the radial slits 109 and one or more flexible flaps 102 thus combines convenient access with spill resistance.

In some embodiments, the top surface 108 includes a plurality of radial slits 109 that extend outwardly from a central portion of the top surface 108 toward its outer edge. These slits 109 divide a portion of the top surface 108 into multiple segments, each segment forming a flexible flap 102. In some embodiments, one or more flexible flaps 102 collectively defines a flexible opening 111 in the top surface 108 which can be expanded or contracted by pressing or pulling on the flaps 102. In some embodiments, each flexible flap 102 is bordered by one or more adjacent radial slits 109, allowing the flexible flaps 102 to bend or flex inwardly or outwardly when engaged with an external object, such as a dog's muzzle. This configuration enables easy access through the top surface 108 while also providing a degree of sealing and containment by virtue of the flexible flaps 102 returning to their original position after use.

In some embodiments, the top surface 108 comprises an aperture 110 in the top surface 108 center area, the aperture 110 in the top surface 108 extending through the top surface into the food chamber 101. Yet in other embodiments, one or more slits 109 extend from an aperture 110 in the top surface 108 towards an outer edge of the top surface 108. In some embodiments, the top surface 108 includes a flexible opening defined by one or more flexible flaps 102 and an aperture 110 in the top surface 108 center area. This configuration enables an animal to access food placed within the food chamber 101 while simultaneously minimizing the likelihood of spillage.

In some embodiments, the animal training device 10 generates a tactile response perceptible to an animal interacting with the flexible opening primarily through the physical properties and the structural design of the flexible flaps 102. When an animal pushes, nudges, or manipulates the flexible flaps 102 to access the food chamber 101, the flaps 102 flex, bend, or return to their original position, creating a recognizable sensation of resistance and movement against the animal's nose, paw, or mouth. This tactile response provides immediate physical feedback to the animal, indicating successful interaction with the opening. Additionally, material choices (such as rubber, silicone, or flexible polymers) can further enhance this tactile effect by offering a distinct texture and springiness that reinforces the animal's understanding of where and how to access the food chamber 101 each time they engage with the apparatus 10. In some embodiments, the device 10 generates audible feedback perceptible to an animal interacting with the device 10.

In some embodiments, a flexible flap 102 is substantially triangular in shape, with a narrow end adjacent to the central portion of the top surface 108 and a wider end proximal to the outer edge of the top surface 108. In some embodiments, a flexible flap 102 is substantially trapezoidal in shape, with a narrow end adjacent to the central portion of the top surface 108 and a wider end proximal to the outer edge of the top surface 108. In other embodiments, a flexible flap 102 defines a shape.

In a preferred embodiment of the instant invention, the body 100 includes a base 107, the base 107 being situated opposite the upper surface 108. In some embodiments, the base 107 is comprised from a durable rubber material or similar resilient material. The base 107 is designed to maintain stability during use, resisting displacement as an animal, such as a dog, interacts with the food chamber 101. Additionally, in some embodiments, the base 107 is comprised from resilient, non-slip rubber or similar material, which further minimizes movement and protects underlying surfaces from scratches. In some embodiments, a base 107 is a flexible membrane molded into the body 100.

In some embodiments of the instant invention, the top surface 108 has an overall diameter larger than an overall diameter of the base 107, such that the side walls of the body 100 extend from the top surface 108 and taper inwardly towards the base 107. In other embodiments, the base 107 has an overall diameter larger than an overall diameter of the top surface 108, such that the side walls of the body 100 extend from the base 107 and taper inwardly towards the top surface 108. Yet in other embodiments, the top surface 108 has an overall diameter equal to an overall diameter of the base 107, such that the side walls of the body 100 extend from the top surface 108 vertically downward and are substantially perpendicular to the top surface 108 and base 107.

In certain embodiments, the top surface 108 is configured to display a distinctive shape, such as the likeness of a dog's head. This surface may incorporate contouring, relief, or patterned features that visually and/or tactilely represent a dog's head, including but not limited to the general outline of the head, ears, snout, and facial features. Furthermore, while a dog's head is referenced as one example, the top surface 108 may alternatively depict other shapes, figures, or designs according to aesthetic or functional considerations. These design elements may serve purposes including product differentiation, user appeal, or enhanced functionality within the context of the device's intended use. In other embodiments, the top surface 108 depicts an overall round shape.

In some embodiments of the instant invention, the base 107 is configured to include an embedded magnet 103, which enables secure magnetic attachment of the device 10 to a metallic or other ferromagnetic surface. Yet in other embodiments, the base 107 is configured to include an embedded magnet 103, which enables secure magnetic attachment to a metallic or other ferromagnetic surface, such as a steel mounting plate 104. In an exemplary embodiment of the instant invention, an embedded magnet 103 is positioned within the device's base 107, allowing the device 10 to be firmly yet removably attached to a metallic or other ferromagnetic surface, such as a steel mounting plate 104. In some embodiments, a portion of the device's body 100 covers a portion of an embedded magnet 103. In some embodiments of the instant invention, an embedded magnet 103 is positioned within the lower portion of the food chamber 101, allowing the device 10 to be firmly yet removably attached to a metallic or other ferromagnetic surface, such as a steel mounting plate 104. In some embodiments, an embedded magnet 103 is positioned within a lower portion of the body 100, allowing the device 10 to be firmly yet removably attached to a metallic or other ferromagnetic surface, such as a steel mounting plate 104. In some embodiments, an embedded magnet 103 is enclosed within a portion the device's body 100 such that the embedded magnet 103 does not directly contact a magnetic surface yet provides a magnetic attachment to the magnetic surface via a magnetic connection. In some embodiments, a surface of an embedded magnet 103 is affixed to a surface of the device 10. In some embodiments, one or more embedded magnets 103 are configured to provide the device 10 with a magnetic attachment to a surface, allowing the device 10 to be firmly yet removably attached to a metallic or other ferromagnetic surface, such as a steel mounting plate 104. In some embodiments of the present device, the embedded magnet 103, facilitates stable placement of the device 10 on doors or other mounting surfaces.

Referencing FIG. 2, in a preferred embodiment of the instant invention, a ferromagnetic plate, such as a steel mounting plate 104 is provided, facilitating the magnetic attachment, via the embedded magnet 103, of the device 10 to the steel mounting plate 104. In some embodiments, a steel mounting plate 104 serves as the anchor for the device 10 on a chosen surface, ensuring secure and versatile placement. In some embodiments, the mounting plate 104 is configured to interface precisely with the embedded magnet 103 within the device 10, enabling quick attachment and removal of the device 10 as needed. In a preferred embodiment, the steel mounting plate 104 comprises a flat design configured for low profile installation on doors, walls, or other surfaces, adapting easily to various environments.

To facilitate user-friendly and non-permanent installation, in some embodiments of the present device 10, a mounting plate 104 is affixed to a surface using one or more adhesive strips 105, preferably of the removable, non-damaging type such as Command-style pull-tab strips. This arrangement protects surfaces from marring or residue while allowing the mounting plate 104 to be repositioned as necessary during training. In some embodiments, a steel mounting plate 104 is affixed using one or more removable, non-damaging adhesive strips 105, ensuring that the device 10 may be easily installed or repositioned without causing damage.

Refencing to FIG. 3, in an exemplary embodiment of the instant invention, a magnet 103, embedded within the base of the food chamber 101, body 100, or base 107 is positioned to align directly with the steel mounting plate 104, which acts as a stable, magnetically receptive anchor point. The mounting plate 104 itself is attached to a chosen surface 121, such as a door 120, using one or more adhesive strips 105. Taken together, the adhesive strips 105 hold the steel plate 104 securely in the desired location, while the magnet 103 in base of the food chamber 101, body 100, or base 107 enables quick and reliable attachment and detachment. This integrated arrangement allows for convenient placement and removal of the device 10 during training or cleaning, while maintaining stability and minimizing the risk of accidental dislodgement or surface damage.

In alternative embodiments, device 10 may be adapted for use on non-magnetic surfaces through the incorporation of different attachment mechanisms. For example, the device 10 may be equipped with buckle straps, allowing secure attachment to doors, cabinets, or panels constructed of wood, glass, or other non-ferrous materials. Alternatively, suction devices may be integrated into device 10 to enable temporary, non-invasive mounting on smooth surfaces such as glass, plastic, or tile. These alternative attachment methods expand the versatility of the device 10, permitting its use in a variety of environments where magnetic mounting is not feasible, and ensuring the progressive training system can be effectively implemented regardless of the substrate or surface composition encountered.

Referring to FIG. 4, one embodiment of a transition plate 106 is shown. The transition plate 106 is a specialized component of the system, designed to facilitate advanced stages of behavioral training an animal, such as a dog. In some embodiments, the transition plate 106 does not contain animal motivational or reward material, such as training treats. The transition plate 106 provides a subtler tactile and visual cue, helping an animal, such as a dog, gradually focus on the learned behavior rather than relying solely on the presence of the original device 10. During the later phases of training, the transition plate 106 replaces the device 10 on the steel mounting plate 104, maintaining magnetic attachment while presenting a less conspicuous target. This progressive reduction in cues is instrumental in promoting long-term behavioral reliability and independence. Constructed from durable materials, such as a durable rubber material or similar resilient material, the transition plate 106 is both robust and lightweight, ensuring ease of use and consistent performance throughout a training process. In some embodiments, a transition plate 106 is comprised from rubber, silicone, or equivalent flexible materials.

In some embodiments, the transition plate 106 includes a first flat surface and an opposed second flat surface. In some embodiments, the transition plate 106 depicts an outline shape of the device 10, such that the transition plate 106 depicts the overall shape of the device 10 from an animal's point of view during a training process. Yet in other embodiments, the transition plate 106 may vary in size, shape, or texture for progressive training.

In some embodiments of the present invention, a transition plate 106 incorporates an embedded magnet 103 similar as discussed above with respect to the body 100, food chamber 101, or base 107. In some embodiments, a transition plate 106 incorporates one or more embedded magnet 103, allowing the transition plate 106 to be firmly yet removably attached to a metallic or other ferromagnetic surface, such as a steel mounting plate 104. In some embodiments, an embedded magnet 103 is positioned within a first surface of transition plate 106, allowing the transition plate 106 to be firmly yet removably attached to a metallic or other ferromagnetic surface, such as a steel mounting plate 104. In an exemplary embodiment of the instant invention, an embedded magnet 103 is positioned within the transition plate's base, allowing the transition plate 106 to be firmly yet removably attached to a metallic or other ferromagnetic surface, such as a steel mounting plate 104. In some embodiments, a portion of the transition plate 106 body 100 covers a portion of an embedded magnet 103. In some embodiments of the present device, the embedded magnet 103, facilitates stable placement of the transition plate 106 on doors or other mounting surfaces. In some embodiments, a transition plate 106 is attached to a chosen surface 121, such as a door 120, using one or more adhesive strips 105. Taken together, the adhesive strips 105 hold the transition plate 106 securely in the desired location, while the embedded magnet 103 enables quick and reliable attachment and detachment.

In alternative embodiments, transition plate 106 may be adapted for use on non-magnetic surfaces through the incorporation of different attachment mechanisms. For example, the transition plate 106 may be equipped with buckle straps, allowing secure attachment to doors, cabinets, or panels constructed of wood, glass, or other non-ferrous materials. Alternatively, suction devices may be integrated into the transition plate 106 to enable temporary, non-invasive mounting on smooth surfaces such as glass, plastic, or tile. These alternative attachment methods expand the versatility of the transition plate 106, permitting its use in a variety of environments where magnetic mounting is not feasible, and ensuring the progressive training system can be effectively implemented regardless of the substrate or surface composition encountered.

In some embodiments, the transition plate 106 generates a tactile response perceptible to an animal interacting with the physical properties and the structural design of transition plate 106. When an animal pushes, nudges, or manipulates the transition plate 106, the transition plate 106 creates a recognizable sensation of resistance and movement against the animal's nose, paw, or mouth. This tactile response provides immediate physical feedback to the animal, indicating successful interaction with the opening. Additionally, material choices (such as rubber, silicone, or flexible polymers) can further enhance this tactile effect by offering a distinct texture and springiness that reinforces the animal's understanding each time they engage with the transition plate 106. In some embodiments, the transition plate 106 generates audible feedback perceptible to an animal interacting with the physical properties and the structural design of transition plate 106.

In one embodiment of the present invention, device 10 may be used to facilitate progressive animal training for tasks such as closing a door 120. Initially, device 10 is positioned off the door 120, or alternatively placed on any stable surface accessible to the animal. In this configuration, the animal, for example, a dog, is allowed to freely interact with the device 10 and access food contained within the food chamber 101 through the flexible flap 102. This introductory phase serves to build the animal's confidence and comfort with the device 10.

Subsequently, the device 10 is mounted onto a door 120 at the animal's natural head height. This is achieved by utilizing the embedded magnet 103 to affix the device 10 to a first surface of a steel plate 104 and utilizing adhesive strips 105, positioned on a second surface of the steel plate 104, to secure the steel plate 104 to the door surface 121. The embedded magnet 103 facilitates rapid, secure attachment to the steel plate 104, and further allows the device 10 to be employed on other magnetic surfaces, such as refrigerators, vehicle doors, or other metallic panels, thereby offering versatility for different training scenarios.

In the next phase, repetition and verbal command are introduced. The handler prompts the animal to push the device 10 toward the door 120, such that the door closes. As the animal performs the action, the handler provides a consistent verbal cue, e.g., “door,” and reinforces the behavior immediately upon successful completion, as indicated by the sound of the door 120 closing. The magnetic attachment ensures that the device remains in a stable, repeatable position throughout training.

To advance the animal's learning, the handler gradually decreases the quantity of food present within the device 10, and instead provides rewards externally while maintaining the established verbal command and reinforcement. This process diminishes the animal's dependence on food within the device 10 and shifts motivation to the completion of the desired task. Once the animal reliably performs the task (e.g., closing the door 120), the device 10 is replaced by a transition plate 106. The transition plate 106 is comprised of a flat structure containing an embedded magnet 103 for continued attachment to the steel plate 104. The transition plate 106 is less visually prominent than the device 10 but maintains comparable tactile and magnetic feedback for the animal, thereby reinforcing the behavior with reduced reliance on the food initially present within the device 10.

Upon successful use of the transition plate 106, the handler removes the transition plate 106, steel mounting plate 104, and adhesive strips 105 entirely. At this stage, the animal completes the door-closing task independently, solely in response to the verbal command. The learned behavior can then be generalized to other doors or magnetic surfaces as desired. Throughout the described method, the device 10 provides a systematic, phased approach to animal training, facilitating reliable task acquisition and behavioral generalization.

In the foregoing description, certain terms have been used for brevity, clearness and understanding; but no unnecessary limitations are to be implied therefrom beyond the requirements of the prior art, because such terms are used for descriptive purposes and are intended to be broadly construed. Moreover, the description and illustration of the inventions is by way of example, and the scope of the inventions is not limited to the exact details shown or described.

Although the foregoing detailed description of the present invention has been described by reference to an exemplary embodiment, and the best mode contemplated for carrying out the present invention has been shown and described, it will be understood that certain changes, modification or variations may be made in embodying the above invention, and in the construction thereof, other than those specifically set forth herein, may be achieved by those skilled in the art without departing from the spirit and scope of the invention, and that such changes, modification or variations are to be considered as being within the overall scope of the present invention. Therefore, it is contemplated to cover the present invention and any and all changes, modifications, variations, or equivalents that fall with in the true spirit and scope of the underlying principles disclosed and claimed herein. Consequently, the scope of the present invention is intended to be limited only by the attached claims, all matter contained in the above description and shown in the accompanying drawings shall be interpreted as illustrative and not in a limiting sense.

Having now described the features, discoveries and principles of the invention, the manner in which the invention is constructed and used, the characteristics of the construction, and advantageous, new and useful results obtained; the new and useful structures, devices, elements, arrangements, parts and combinations, are set forth in the appended claims.

It is also to be understood that the following claims are intended to cover all of the generic and specific features of the invention herein described, and all statements of the scope of the invention which, as a matter of language, might be said to fall therebetween.

What is claimed is:

1. An animal training device comprising:
a body defining an internal space, the body including sides that extend from a top surface to a base;
wherein the base is situated opposite from the top surface; and
wherein at least a portion of the body's material is arranged to surround and enclose the internal space.

2. The animal training device as claimed in claim 1, wherein the internal space is a food chamber.

3. The animal training device as claimed in claim 1, the body further comprising an embedded magnet, wherein the embedded magnet is positioned in the base.

4. The animal training device as claimed in claim 3, wherein the embedded magnet is configured to provide a magnetic attachment of the animal training device to a ferromagnetic surface.

5. The animal training device as claimed in claim 4, wherein the ferromagnetic surface is a steel plate, and wherein the animal training device is removably magnetically affixed to the plate.

6. The animal training device as claimed in claim 1, wherein the top surface is formed from a durable, resilient material.

7. The animal training device as claimed in claim 1, wherein the top surface comprises:
a generally planar surface adapted to cover a portion of the internal space;
a central area located on the top surface;
a plurality of radial slits extending from the central area of the top surface toward an outer edge of the top surface;
one or more flexible flaps defining a flexible opening in the top surface; and
wherein each one or more flexible flap is bounded by one or more adjacent radial slits.

8. The animal training device as claimed in claim 7, wherein at least one flexible flap is integrated with the top surface.

9. The animal training device as claimed in claim 8, wherein each flexible flap is substantially triangular in shape, with a narrow end adjacent to the central portion of the top surface and a wider end proximal to the outer edge of the top surface.

10. A method of training an animal, the method comprising:
positioning an animal training device on a first surface accessible to an animal, wherein the animal training devices comprises a body defining an internal space, the body including sides that extend from a top surface to a base, wherein the base is situated opposite from the top surface, and wherein at least a portion of the body's material is arranged to surround and enclose the internal space;
providing a reward material within the internal space of the device; and
allowing the animal to freely interact with the device for a first amount of time and access food through a flexible opening in the top surface to build comfort and confidence with the device.

11. The method of claim 10, the flexible opening comprising one or more flexible flaps, wherein each one or more flexible flap is bounded by one or more adjacent radial slits, and wherein the one or more adjacent radial slits extend from the central area of the top surface toward an outer edge of the top surface.

12. The method of claim 11, further comprising mounting the device onto a door at the animal's head height by magnetically affixing the device to a first side of a steel plate and using adhesive strips to affix a second side of the steel plate to a door surface.

13. The method of claim 12, further comprising encouraging the animal to push the device in a first direction, wherein the first direction moves the door from a first position towards a second position.

14. The method of claim 13, further comprising gradually decreasing the quantity of food present within the device.

15. The method of claim 14, further comprising providing rewards externally while maintaining verbal commands and reinforcement, to transition the animal's motivation from food dependency to task completion.

16. The method of claim 15, further comprising replacing the device with a transition plate containing an embedded magnet and minimal visual cues.

17. The method of claim 16, further comprising removing the transition plate, such that the animal reliably performs the door-closing task in response to a verbal command, generalizing the learned behavior to other doors or surfaces.

18. An animal training device comprising:
a body defining an internal space, the body including sides that extend from a top surface to a base;
wherein the base is situated opposite from the top surface; and
wherein at least a portion of the body's material is arranged to surround and enclose the internal space.

19. The animal training device as claimed in claim 18, wherein the top surface comprises a plurality of radial slits extending from the central area toward an outer edge of the top surface, wherein the radial slits are configured to form a flexible opening that allows access through the top surface while forming a spill-resistant opening that allows animal access to food contained within the internal space while minimizing spillage.

20. The animal training device as claimed in claim 18, wherein moving the flexible opening from a first configuration to a second configuration thereby produces a tactile response perceptible to an animal interacting with the flexible opening.
